(19) United States
(12) Patent Application Publication
(10) Pub. No.: US 2015/0002888 A1
(43) Pub. Date: Jan. 1, 2015

(54) SETTING INFORMATION STORAGE DEVICE AND IMAGE PROCESSING DEVICE

(71) Applicant: Sharp Kabushiki Kaisha, Osaka-shi, Osaka (JP)

(72) Inventor: Kunihiko Tsujimoto, Osaka-shi (JP)

(21) Appl. No.: 14/376,449

(22) PCT Filed: Feb. 7, 2013
(86) PCT No.: PCT/JP2013/052912

§ 371 Date: Aug. 4, 2014

(30) Foreign Application Priority Data
Feb. 28, 2012 (JP) 2012-042501

(51) Int. Cl. H04N 1/00; G06F 21/31

(52) U.S. Cl. CPC H04N 1/0084; G06F 21/31; H04N 1/00278
USPC 358/1.14; 726/16

(57) ABSTRACT

A device control section (21), after a log-in process, creates second setting information associating (i) first setting information corresponding to the content of an operation performed before the log-in with (ii) the logged-in user, and causes a second setting information storage section (42) to store the second setting information. This arrangement improve the user's convenience in use of a setting information storage device for storing, separately for each user, setting information corresponding to the content of the user's operation.

### TECHNICAL FIELD

The present invention relates to (i) a setting information storage device for storing setting information corresponding to the content of a user's operation and to (ii) an image processing apparatus including the setting information storage device.

### BACKGROUND ART

There has been known a technique in which a web application (application software) operating on a web server causes a web browser to store, on a computer of a user who has used the web application, a cookie, that is, setting information corresponding to the content of the user's operation.

With the above technique, in a case where the user uses the web application from the web browser, the cookie stored in the user's computer is automatically transmitted to the web application. This allows the web application to (i) identify the user (or the web browser) and to (ii) automatically carry out a process corresponding to the content of an operation that the user performed before. Specifically, the web application carries out, for example, the function of automatically permitting the user to log in to the web application from a second time on.

Patent Literature 1, for example, discloses a system involving a relay server connected to a client apparatus and web servers, the relay server (i) analyzing a cookie included in a web data request transmitted from the client apparatus, (ii) obtaining, from a web server corresponding to the web data request, web data that meets the web data request, and (iii) transmitting the web data to the client apparatus.

A client apparatus shared by a plurality of users typically manages cookies separately for each user in order to avert security risks such as private information leakage.

Patent Literature 2 discloses an image forming apparatus shared by a plurality of users, the image forming apparatus being arranged to (i) permit only a user who has logged in to use apparatus functions of the image forming apparatus and to (ii) display, after the user has logged in, a user initial screen showing function buttons for apparatus functions that the user who has logged in is authorized to use. Further, Patent Literatures 3 and 4 each disclose an image forming apparatus that obtains advertisement information from an advertisement information distribution server to display the advertisement information in a case where the image forming apparatus has received no operation from a user for over a predetermined time period.

### CITATION LIST

Patent Literature 1
Japanese Patent Application Publication, Tokukai, No. 2003-44396 A (Publication Date: Feb. 14, 2003)

Patent Literature 2
Japanese Patent Application Publication, Tokukai, No. 2011-077655 A (Publication Date: Apr. 14, 2011)

Patent Literature 3
Japanese Patent Application Publication, Tokukai, No. 2009-021742 A (Publication Date: Jan. 29, 2009)

Patent Literature 4
Japanese Patent Application Publication, Tokukai, No. 2009-020561 A (Publication Date: Jan. 29, 2009)

### SUMMARY OF INVENTION

### Technical Problem

An apparatus for which a user needs to perform a log-in process in order to use such apparatus functions as those of Patent Literature 2 may, in order to effectively utilize a waiting time period during which no user is in a logged-in state, adopt a technique such as that of Patent Literature 3 or 4 to display a web page of information such as advertisement information provided by an external device. (This arrangement has been conceived by the inventor of the present invention and is not a publicly known technique).

Such an apparatus, which displays a web page of information such as advertisement information during a time period during which no user is in a logged-in state (that is, all users are in a logged-out state), may be arranged to (i) allow any user to perform such an operation on a web application as an operation for a transition to a different web page without performing a log-in process and to (ii) require users to perform a log-in process to perform an operation related to any of such apparatus functions of the apparatus as printing a web page (for example, functions other than the function of viewing a web page). (This arrangement has been conceived by the inventor of the present invention and is not a publicly known technique).

According to the above arrangement, however, setting information is managed separately for each user. The above arrangement thus fails to allow a user to directly use, after logging in to a web application, setting information corresponding to an operation that the user performed on the web application before logging in. Consequently, the above arrangement problematically impairs usability.

The above problem may be stated differently as follows: An apparatus shared by a plurality of users manages setting information separately for each user. Thus, the apparatus is, although capable of obtaining setting information entered while a user is in a logged-in state, incapable of obtaining setting information entered before the user logs in (that is, setting information associated with no user) in order to use such setting information after the user has logged in. Consequently, the apparatus cannot, after the user has logged in, refer to setting information corresponding to the content of an operation performed before the user logged in. This arrangement unfortunately requires the user to, after logging in, perform an operation again that the user performed before logging in, with the result of impaired usability.

The present invention has been accomplished in view of the above problem. It is an object of the present invention to improve the user's convenience in use of a setting information storage device for storing, separately for each user, setting information corresponding to the content of the user's operation.

### Solution to Problem

A setting information storage device of one mode of the present invention is a setting information storage device (i) including an operation section for accepting an operation input by a user and (ii) storing setting information corresponding to a content of an operation performed by the user on the operation section, the setting information storage device including: a storage section; a log-in process section for carrying out a log-in process of determining on a basis of a result of a user authentication process whether to permit a user to log in; and a setting information control section for (i) causing the storage section to store first setting information, which is setting information corresponding to a content of an operation performed by a user while the user is not in a logged-in state and (ii) after the log-in process, creating second setting information, which associates the first setting information, corresponding to the content of the operation performed by the user before the log-in process, with the logged-in user and causing the storage section to store the second setting information.

### Advantageous Effects of Invention

A setting information storage device of one mode of the present invention creates second setting information associating (i) first setting information corresponding to the content of an operation performed before a log-in process with (ii) the logged-in user, and thus allows the user to, after the log-in, directly use the content of an operation performed immediately before the log-in. The setting information storage device consequently eliminates the need for the user to, after log-in, perform again the same operation as the user performed before the log-in, and improves the user's convenience.

### BRIEF DESCRIPTION OF DRAWINGS

FIG. 1 is an explanatory diagram schematically illustrating a configuration of a setting information storage system including a setting information storage device of one embodiment of the present invention.

FIG. 2 is a flowchart illustrating a flow of a process carried out by the setting information storage device.

FIG. 3 is an explanatory diagram illustrating an example display screen displayed by a display section of the setting information storage device.

FIG. 4 is an explanatory diagram illustrating an example display screen displayed by the display section of the setting information storage device.

FIG. 5 is a flowchart illustrating a flow of a process for a case of the setting information storage device carrying out a process involving use of a web browser.

FIG. 6 is an explanatory diagram schematically illustrating a structure of second setting information stored in the setting information storage device.

FIG. 7 is an explanatory diagram illustrating an example user setting file stored in the setting information storage device.

FIG. 8 is an explanatory diagram illustrating a structure of a user management table stored in the setting information storage device.

FIG. 9 is an explanatory diagram illustrating example setting information transmitted from the setting information storage device to a server device.

FIG. 10 is an explanatory diagram illustrating an example setting information storage request transmitted from the server device to the setting information storage device.

FIG. 11 is an explanatory diagram illustrating an example display screen displayed by the display section of the setting information storage device.

FIG. 12 is an explanatory diagram illustrating an example display screen displayed by the display section of the setting information storage device.

FIG. 13 is an explanatory diagram illustrating an example display screen displayed by the display section of the setting information storage device.

FIG. 14 is an explanatory diagram illustrating an example printed material printed by the setting information storage device.

FIG. 15 is an explanatory diagram illustrating an example display screen displayed by the display section of the setting information storage device.

FIG. 16 is an explanatory diagram illustrating an example display screen displayed by the display section of the setting information storage device.

FIG. 17 is an explanatory diagram illustrating an example display screen displayed by the display section of the setting information storage device.

### DESCRIPTION OF EMBODIMENTS

(1-1. Overall Configuration of Multifunction Peripheral Control System 1)

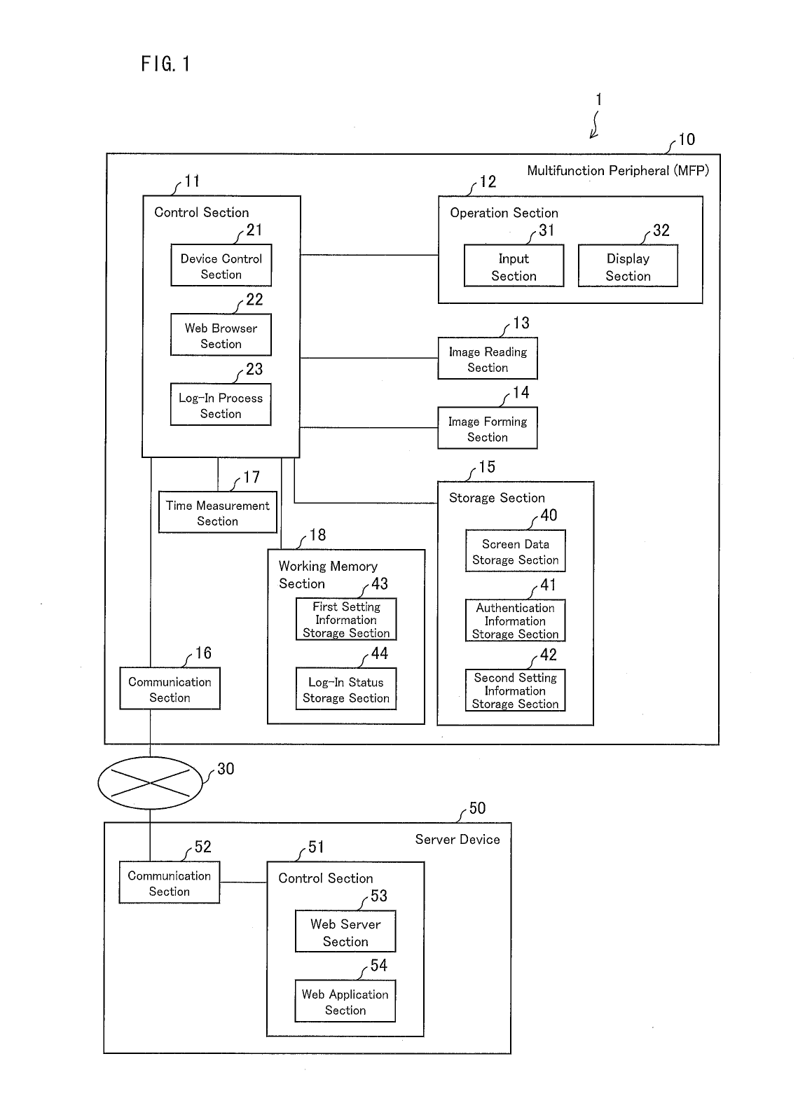

FIG. 1 is an explanatory diagram illustrating a configuration of a multifunction peripheral control system 1 (setting information storage system) of the present embodiment. As illustrated in FIG. 1, the multifunction peripheral control system 1 includes a multifunction peripheral (setting information storage device, image processing apparatus) 10 and a server device (web server) 50, which are communicably connected to each other over a communication network 30. The multifunction peripheral control system 1 may include a plurality of multifunction peripherals 10 and/or a plurality of server devices 50. The communications network 30 can be (i) a wired communication means such as an IEEE 1394 line, a USB line, a power line, a cable TV line, a telephone line, an ADSL line, and a serial cable or (ii) a wireless communication means such as infrared radiation (for example, IrDA infrared radiation and remote control infrared radiation), Bluetooth (registered trademark), IEEE802.11 wireless, HDR, a mobile phone network, a satellite line, and a terrestrial digital network. The multifunction peripheral 10 and the server device 50 are arranged to communicate with each other in accordance with the HTTP (hyper text transfer protocol), which is used for communication between a web server and a web browser (for example, to request and transmit a web page).

(1-2. Arrangement of Multifunction Peripheral 10)

The multifunction peripheral 10 is a digital or analog multifunction peripheral that (i) has a function as a web browser, that is, the function of receiving HTML (hyper text mark-up language) control information from the server device 50 in accordance with the HTTP, and that (ii) carries out its various functions (for example, a printer function, a copying function, a scanner function, a facsimile function, an image data filing function, and a web browser function) on the basis of the control information received. The present embodiment is a case of applying the present invention to a multifunction peripheral having the above functions. The present invention is, however, not limited to such an arrangement, and may be applied to any device for storing setting information corresponding to the content of a user's operation. The present invention may be applied to, for example, (i) an image processing apparatus having one or more of the above functions, (ii) an Internet terminal such as a personal computer, (iii) an automated teller machine (ATM) at a bank or the like, or (iv) a machine installed at a convenience store or the like for issuing various tickets.

The multifunction peripheral 10 includes a control section (setting information control section) 11, an operation section 12, an image reading section 13, an image forming section 14, a storage section 15, a communication section 16, a time measurement section 17, and a working memory section 18. The control section 11 includes a device control section (setting information control section) 21, a web browser section (setting information control section) 22, and a log-in process section 23. The storage section 15 includes a screen data storage section 40, an authentication information storage section 41, and a second setting information storage section (storage section, second storage section) 42. The working memory section 18 includes a first setting information storage section (storage section, first storage section) 43 and a log-in status storage section 44.

The operation section 12 is a user interface that notifies the user of various information items and that accepts an input from the user. The operation section 12 includes (i) an input section (operation input section) 31 including various input keys and (ii) a display section 32 including, for example, a liquid crystal display (LCD). The input section 31 and the display section 32 are not particularly limited in their respective arrangements. The operation section 12 may include, for example, a touch panel that integrally combines the input section 31 with the display section 32.

The image reading section 13 carries out a scanner function of (i) scanning a character, image and the like printed on a document and thus (ii) producing image data thereof.

The image forming section 14 prints, on a recording sheet such as paper, an image represented by image data. Specifically, the image forming section 14 carries out (i) a copying function of printing an image represented by image data inputted from the image reading section 13 and (ii) a printer function of printing an image represented by image data inputted from an external device.

The communication section 16 is a communication interface for communication with an external device such as the server device 50 over the communication network 30. The communication section 16 of the present embodiment communicates with the server device 50 in accordance with the HTTP.

The control section 11 is a computer device including, for example, (i) an arithmetic process section (not shown) such as a CPU and a dedicated processor and (ii) a storage section (not shown) such as a RAM, a ROM, and a HDD. The control section 11 (i) reads, from the storage section, various information items and programs for carrying out various controls and (ii) executes the programs for the device control section 21, the web browser section 22, and the log-in process section 23 to carry out their respective functions.

The device control section 21 controls various functions of the multifunction peripheral 10. Specifically, the device control section 21 controls the respective operations of the operation section 12 (that is, the input section 31 and the display section 32), the image reading section 13, the image forming section 14, the storage section 15, the communication section 16, the time measurement section 17, and the working memory section 18. The device control section 21, for example, controls the operation of the image reading section 13 so that the image reading section 13 scans a document for data on an image of that document. The device control section 21 also controls the operation of the image forming section 14 so that the image forming section 14 forms (outputs), on a recording sheet, an image represented by image data.

The web browser section 22 (i) operates in accordance with widely used web browser software and (ii) communicates, via the communication section 16, with a web server section 53 included in the server device 50. Specifically, in a case where a user has requested, from the operation section 12, to access a website provided by a web application section 54 of the server device 50, the web browser section 22 transmits to the device control section 21 a web data obtaining request corresponding to the access request. This causes the device control section 21 to (i) control the communication section 16 on the basis of the web data obtaining request so that the communication section 16 transmits the web data obtaining request to the server device 50 and to thus (ii) obtain web data from the server device 50 to carry out a process corresponding to that web data. The multifunction peripheral 10 transmits a web data obtaining request to the server device 50 by means of, for example, a Get command or Post command of the HTTP. The server device 50, in response, transmits back to the multifunction peripheral 10 web data (for example, display screen data) that meets the web data obtaining request transmitted from the multifunction peripheral 10. In a case where the display screen data transmitted back from the server device 50 is written in HTML, the web browser section 22 analyzes the content of the screen data to create screen data to be displayed by the display section 32.

The web browser section 22, in a case where it has received from the server device 50 a request to create setting information (for example, a cookie) corresponding to the content of a user's operation, informs the device control section 21 of that setting information. The device control section 21 creates setting information that meets the request, and causes the first setting information storage section 43 of the working memory section 18 or the second setting information storage section 42 of the storage section 15 to store the setting information. The setting information includes various setting information items to be set by the web application section 54 (for example, information for the user's identification, the user's settings for a website, and history such as the date and time at which the user viewed the website and the number of the user's visits to the website). This will be described later in detail.

The working memory section 18 is a memory for temporarily storing various data for use by the control section 11. The working memory section 18 includes a volatile memory such as a dynamic random access memory (DRAM). This means that information stored in the working memory section 18 is erased when the multifunction peripheral 10 is turned off. The working memory section 18 includes a recording medium that requires a shorter time in reading and writing data than a recording medium included in the storage section 15.

The working memory section 18 includes a first setting information storage section 43 and a log-in status storage section 44.

The first setting information storage section 43, when a user has not logged in yet, has stored therein, in association with a user name indicating that the user has not logged in yet, setting information (first setting information) corresponding to the content of an operation performed by the user when the user has not logged in yet. The first setting information storage section 43, after the user has logged in, has stored therein setting information (second setting information) in which the above setting information (first setting information), stored when the user has not logged in yet, is associated with the logged-in user. The setting information (second setting information), which is associated with the logged-in user, is sequentially updated in correspondence with the content of an operation performed by the user while the user is in a logged-in state.

The log-in status storage section 44 has stored therein (i) information indicative of whether or not a user is in a logged-in state and (ii) in a case where a user is in a logged-in state, information for identification of the logged-in user (for example, a login name).

The storage section 15 is, for example, a non-volatile memory including a hard disc drive (HDD), and includes an authentication information storage section 41 and a second setting information storage section 42. The storage section 15 has stored therein information that is maintained (not erased) even when the multifunction peripheral 10 is turned off.

The screen data storage section 40 has stored therein screen data to be displayed by the display section 32. The screen data storage section 40 has stored therein, for example, (i) authentication screen data that is displayed by the display section 32 for a user authentication process (log-in process) and (ii) operation screen data that is displayed by the display section 32 when (i) a user is in a logged-in state and (ii) no web application is running.

The authentication information storage section 41 has stored therein user identification information for a user who is permitted to log in to the multifunction peripheral 10 (for example, a user name, a user ID, a password, or a combination thereof).

The second setting information storage section 42 has stored therein, separately for each user, setting information corresponding to the content of an operation performed by the user on the multifunction peripheral 10 (that is, setting information associated with the user; second setting information). The present embodiment is arranged such that setting information corresponding to the content of an operation performed by a user while the user is in a logged-in state is (i) temporarily stored in the first setting information storage section 43 of the working memory section 18 while the user is in that logged-in state and is then (ii) stored in the second setting information storage section 42 of the storage section 15 when the user logs out.

The present embodiment is further arranged to, in a case where a user has performed a log-in process after setting information (first setting information) corresponding to the content of an operation performed by the user while the user has not logged in yet is stored in the first setting information storage section 43 of the working memory section 18, (i) read from the second setting information storage section 42 setting information (second setting information) for the logged-in user, (ii) combine the setting information (first setting information) stored in the first setting information storage section 43 with the setting information (second setting information) read from the second setting information storage section 42 to create new setting information (second setting information), and (iii) stores that newly created setting information in the first setting information storage section 43. The present embodiment is still further arranged to, when the user logs out, (i) cause the second setting information storage section 42 to store the setting information (second setting information) stored in the first setting information storage section 43 for the user in the logged-in state or (ii) on the basis of the setting information (second setting information) stored in the first setting information storage section 43 and associated with the user in the logged-in state, update the setting information (second setting information) stored in the second setting information storage section 42 for that user.

The log-in process section 23 carries out a user authentication process (log-in process) by checking whether user authentication information inputted by a user from the input section 31 matches authentication information stored in the authentication information storage section 41 for a user who is permitted to log in to the multifunction peripheral 10.

The time measurement section 17 measures, for example, (i) a time period that has elapsed after a user last performed an operation on the multifunction peripheral 10, (ii) a time period that has elapsed after a cookie was last stored in the first setting information storage section 43, and (iii) a time period that has elapsed after the last user logged out.

(1-3. Arrangement of Server Device 50)

The server device 50, as illustrated in FIG. 1, includes a control section 51 and a communication section 52. The control section 51 includes a web server section 53 and a web application section 54. The control section 51 may include a plurality of web application sections.

The control section 51 is a computer device including, for example, (i) an arithmetic process section (not shown) such as a CPU and a dedicated processor and (ii) a storage section (not shown) such as a RAM, a ROM, and a HDD. The control section 51 (i) reads, from the storage section, various information items and programs for carrying out various controls and (ii) executes the programs for the web server section 53 and the web application section 54 to carry out their respective functions.

The communication section 52 communicates with the multifunction peripheral 10 over, for example, a LAN or an Internet line. The communication section 52 communicates with the multifunction peripheral 10 in accordance with the HTTP communications protocol.

The web server section 53 operates in accordance with widely used web server software. The web server section 53 has the function of (i) receiving a request (for example, an HTTP request) from the multifunction peripheral 10 via the communication section 52, (ii) obtaining from the web application section 54 a file, image data, print data, control information and/or the like that meet the request, and (iii) transmitting the obtained data to the multifunction peripheral 10 via the communication section 52.

The web application section 54 operates in accordance with a predetermined web application in response to an instruction from the web server section 53. The web application section 54, in other words, operates in accordance with any of various web applications operating on a web server. Examples of such web applications include (i) an application for providing the content of a website on the Internet and (ii) a multifunction peripheral control application that operates in cooperation with the multifunction peripheral 10 to control the operation of the multifunction peripheral 10.

In a case where, for instance, the web server section 53 has received from the multifunction peripheral 10 a request (HTTP request) to transmit display screen data, the web application section 54 operates in accordance with an application for transmitting display screen data. Specifically, the web application section 54, in the above case, reads from a storage section (not shown) HTML data on a display screen as requested, and transmits the HTML data to the web server section 53.

In a case where the web server section 53 has received from the multifunction peripheral 10 a request to transmit print data, the web application section 54 operates in accordance with a printing application. Specifically, the web application section 54, in the above case, obtains print data with a specified file name from a folder having a name specified in the transmission request, and transmits the print data to the web server section 53.

The web application section 54, in a case where it has been accessed by the multifunction peripheral 10, transmits to the multifunction peripheral 10 via the web server section 53 and the communication section 52 a request to create a cookie (setting information) corresponding to the content of a user's operation on the multifunction peripheral 10. Further, the web application section 54, in a case where it has received from the multifunction peripheral 10 via the communication section 52 information including a cookie, carries out a process corresponding to that cookie.

(1-4. Outline of Process Carried Out by Multifunction Peripheral 10)

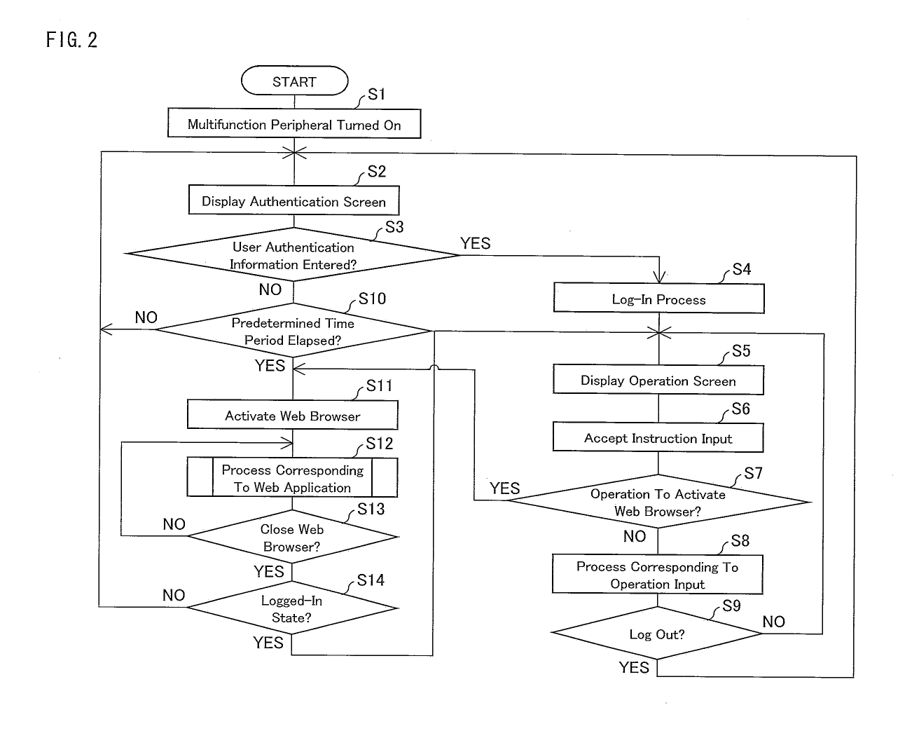

With reference to FIG. 2, the description below outlines a process carried out by the multifunction peripheral 10. FIG. 2 is a flowchart illustrating the flow of a process carried out by the multifunction peripheral 10.

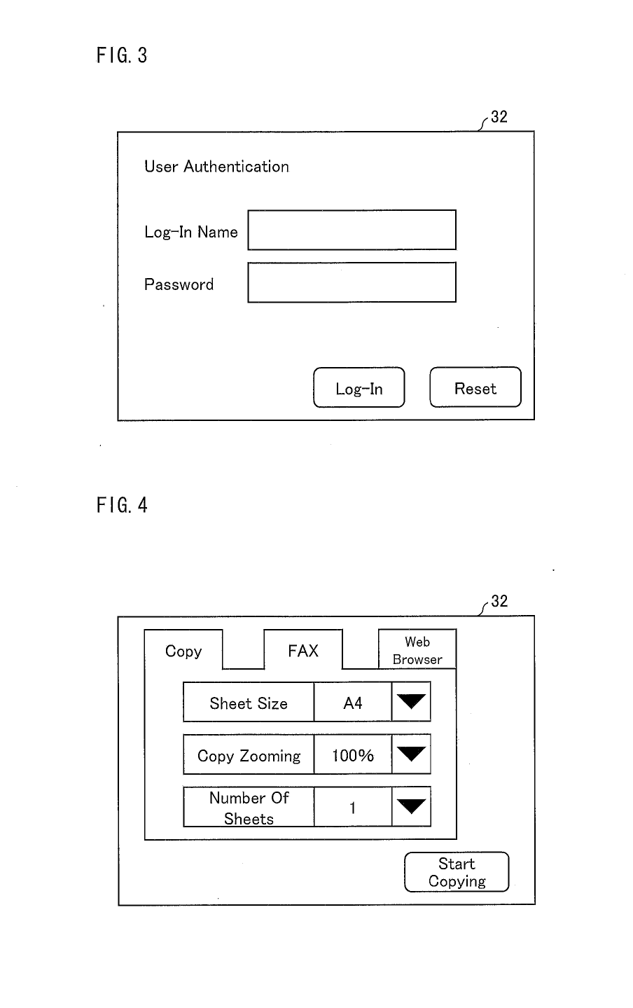

First, in a case where the multifunction peripheral 10 is turned on (S1), the device control section 21 reads from the screen data storage section 40 screen data on an authentication screen, and causes the display section 32 to display the authentication screen (S2). FIG. 3 is an explanatory diagram illustrating an example authentication screen displayed by the display section 32. The present embodiment is, as illustrated in FIG. 3, arranged to prompt a user who wants to log in to enter a login name (user name, user ID) and a password as user authentication information.

Next, the device control section 21 determines whether user authentication information has been entered from the operation section 12 (S3).

In a case where the device control section 21 has determined that user authentication information has been entered, the device control section 21 causes the log-in process section 23 to carry out a log-in process (S4).

The log-in process section 23 carries out a user authentication process (log-in process) by checking whether the user authentication information entered by the user from the operation section 12 matches any user authentication information stored in the authentication information storage section 41 for a user who is permitted to log in to the multifunction peripheral 10.

Specifically, in a case where user authentication information stored in the authentication information storage section 41 for a user who is permitted to log in to the multifunction peripheral 10 includes user authentication information that matches the user authentication information entered by the user, the log-in process section 23 (i) permits the user to log in and (ii) causes the log-in status storage section 44 of the working memory section 18 to store information indicating that a user is in a logged-in state and information on identification of the logged-in user (for example, a login name). In a case where the user authentication information entered by the user fails to match any user authentication information stored in the authentication information storage section 41 for a user who is permitted to log in to the multifunction peripheral 10, the device control section 21 returns to the step S2 to prompt the user to enter user authentication information again.

When the log-in process section 23 has finished the log-in process, the device control section 21 reads from the screen data storage section 40 screen data on an operation screen for the multifunction peripheral 10, and causes the display section 32 to display the operation screen (S5) to accept an instruction input by the user on the operation screen (S6).

FIG. 4 is an explanatory diagram illustrating an example operation screen displayed by the display section 32. The example illustrated in FIG. 4 shows an operation screen including (i) a “COPY” tag for selecting a copying function, (ii) a “FAX” tag for selecting a facsimile function, and (iii) a “WEB BROWSER” tag for selecting a web browser function. The example illustrated in FIG. 4 shows a state in which the “COPY” tag has been selected, and thus shows an operation screen including (i) an image for selecting setting items related to the copying function (namely, a sheet size, a copy zooming, and the number of sheets) and (ii) an image of a copying start button for an instruction to start copying. The present embodiment is arranged such that the “COPY” tag is selected by default. The present invention is, however, not limited to such an arrangement, and may be arranged such that another function is selected by default. Further, the example illustrated in FIG. 4 is an example of an operation image including the individual tags for selecting the copying function, the FAX function, and the web browser function. The present invention is, however, not limited to such an arrangement, and may be arranged to display an operation screen including a tag for selecting another apparatus function (for example, a scanner function, an image data transmitting function, or an image filing function) in addition to the above functions or instead of all or part of the above functions.

Next, the device control section 21 determines whether the operation input accepted in S6 is an operation to activate a web browser (in the present embodiment, an operation to select the “WEB BROWSER” tag) (S7). In a case where the device control section 21 has determined that the operation input accepted in S6 is an operation to activate a web browser, the device control section 21 proceeds to carry out a step S11 described below.

In a case where the device control section 21 has determined that the operation input accepted in S6 is not an operation to activate a web browser, the device control section 21 controls a corresponding section of the multifunction peripheral 10 to cause that section to carry out a process corresponding to the operation input accepted in S6 (S8). The device control section 21 then determines whether to log out the user (S9). In a case where the device control section 21 has determined on not logging out the user, the device control section 21 returns to S5. In a case where the device control section 21 has determined on logging out the user, the device control section 21 returns to S2. In the case of logging out the user, the log-in process section 23 updates information stored in the log-in status storage section 44 and indicative of whether or not a user is in a logged-in state so that the information indicates that no user is in a logged-in state.

In a case where the device control section 21 has determined in S3 that no user authentication information has been entered, the device control section 21 determines, on the basis of a time period that has elapsed, as measured by the time measurement section 17, after the display section 32 started to display the authentication screen, whether a predetermined time period has elapsed after the display section 32 started to display the authentication screen (S10). In a case where the device control section 21 has determined that the predetermined time period has not elapsed, the device control section 21 returns to the step S2 for continued display of the authentication screen.

In a case where (i) the device control section 21 has determined in S10 that the predetermined time period has elapsed or (ii) the device control section 21 has determined in S7 that the operation input accepted in S6 is an operation to activate a web browser, the device control section 21 activates the web browser section 22 (S11), and accesses the server device 50 to cause a corresponding section of the multifunction peripheral 10 to carry out a process corresponding to a web application operating on the server device 50 (S12).

Then, the device control section 21 determines whether to end the operation of the web browser section 22 (S13). In a case where the device control section 21 has determined on not ending the operation, the device control section 21 continues carrying out the step S12. In a case where the device control section 21 has determined on ending the operation of the web browser section 22, the device control section 21 determines whether a user is in a logged-in state (S14). In a case where the device control section 21 has determined that a user is in a logged-in state, the device control section 21 proceeds to carry out the step S5. In a case where the device control section 21 has determined that no user is in a logged-in state, the device control section 21 proceeds to carry out the step S2. The steps S11 to S14 will be described later in detail.

(1-5. Process of Activating Web Browser)

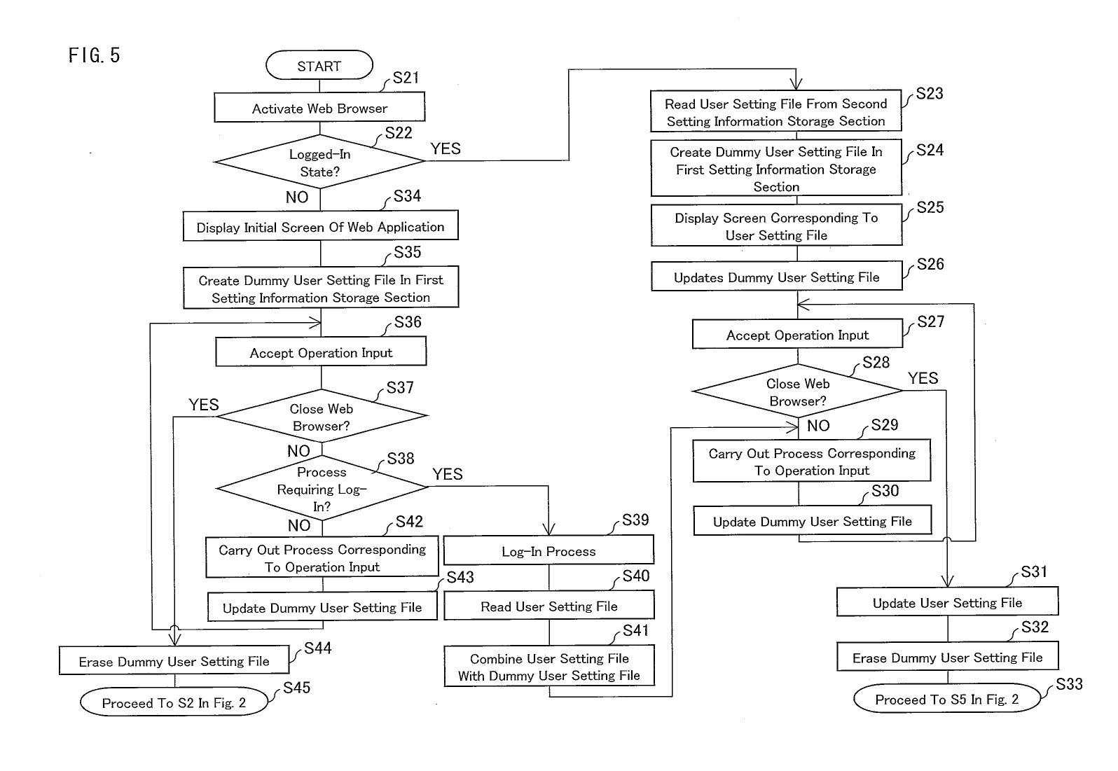

FIG. 5 is a flowchart illustrating a process carried out for a case of the multifunction peripheral 10 using the web browser function to use a web service provided by the server device 50 (specifically, the web application section 54). The flowchart, in other words, illustrates details of the steps S11 to S14 in FIG. 2.

First, in a case where the device control section 21 has determined that (i) no operation input has been performed by the user by a time point at which the predetermined time period has elapsed after the display section 32 started to display the authentication screen (YES in S10 of FIG. 2) or that (ii) the user has requested to activate a web browser (YES in S7 of FIG. 2), the device control section 21 activates the web browser section 22 (S21).

Next, the device control section 21 determines, on the basis of information stored in the log-in status storage section 44, whether a user is in a logged-in state (S22).

In a case where the device control section 21 has determined in S22 that a user is in a logged-in state, the device control section 21 (i) reads from the second setting information storage section 42 a user setting file (second setting information), which is setting information for the logged-in user (S23), (ii) creates a temporary user setting file (second setting information) corresponding to the user setting file read from the second setting information storage section 42, and (iii) causes the first setting information storage section 43 to store the temporary user setting file (S24). The device control section 21 of the present embodiment may alternatively store, in the first setting information storage section 43 as a temporary user setting file, a user setting file itself read from the second setting information storage section 42. In a case where (i) the second setting information storage section 42 has stored therein no user setting file for the logged-in user or (ii) a user setting file stored in the second setting information storage section 42 for the logged-in user includes setting information having an expiration time set therefor and the setting information has already expired, the device control section 21 may newly create a temporary user setting file (second setting information) for the logged-in user and cause the first setting information storage section 43 to store the newly created temporary user setting file.

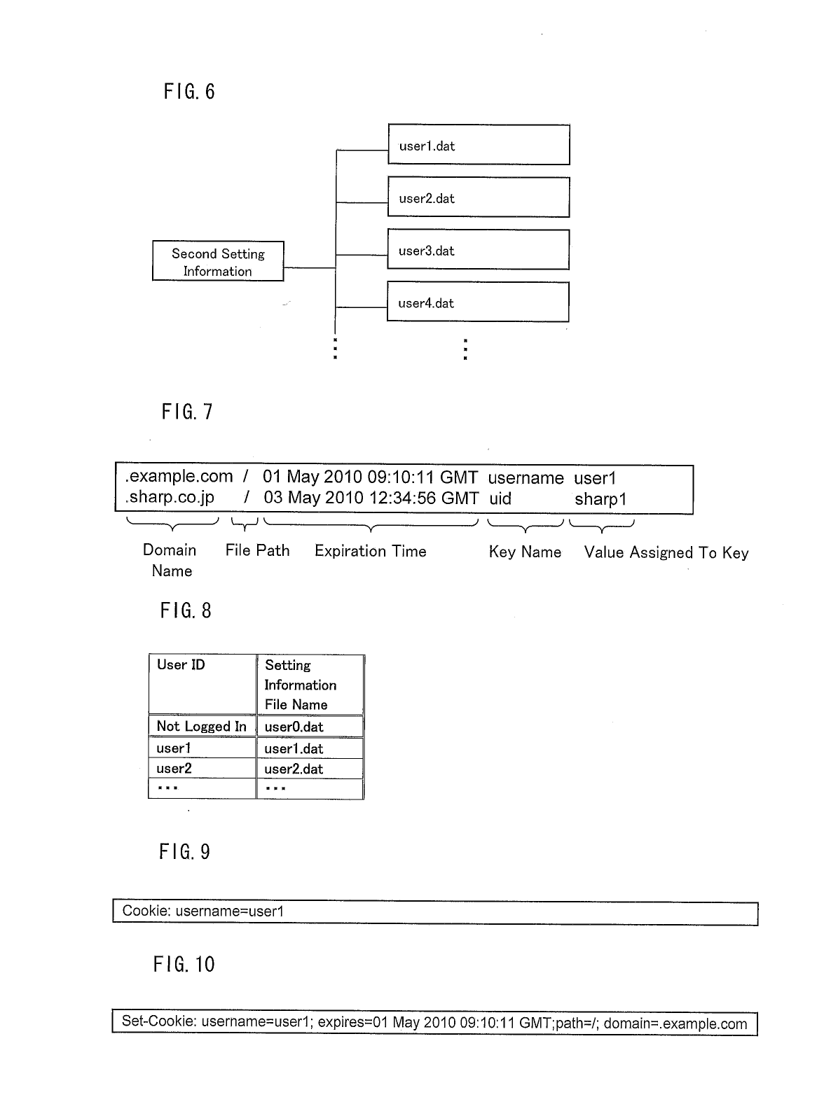

FIG. 6 is an explanatory diagram schematically illustrating a structure of user setting files (second setting information) stored in the second setting information storage section 42 for individual users. The second setting information storage section 42, as illustrated in FIG. 6, has stored therein user setting files (“user1.dat”, “user2.dat”, “user3.dat”, “user4.dat”, . . . ) separately for each individual user. The user setting files shown in FIG. 6 are labeled “user1”, “user2”, “user3”, “user4”, . . . to indicate the respective user names of the individual users.

FIG. 7 is an explanatory diagram illustrating example user setting files, the user setting files being cookies. The example of FIG. 7 shows cookies each including a domain name, a file path, an expiration time, a key name, and a value assigned to the key. Specifically, the user setting file on the first row of FIG. 7 shows (i) a domain name (“.example.com”) on the first column, (ii) a file path (“/”) on the second column, (iii) an expiration time (“1 May 2010 09:10:11”) on the third column, (iv) a key name (“username”) on the fourth column which key name identifies information (cookie) that software (that is, the web application section 54) on the server device 50 causes the multifunction peripheral 10 to store, and (v) a value (“user1”) on the fifth column which value (user ID) is assigned to the key on the fourth column.

FIG. 8 is an explanatory diagram illustrating a structure of a user management table stored in the storage section 15. As illustrated in FIG. 8, the device control section 21, when causing the second setting information storage section 42 of the storage section 15 or first setting information storage section 43 of the working memory section 18 to store a user setting file, creates a management table that associates a user ID with the name of that user setting file (setting information), and causes the storage section 15 to store the management table. The example of FIG. 8 shows that (i) the user with the login name (user ID) “user1” is associated with the user setting file “user1.dat” and that (ii) the user with the login name “user2” is associated with the user setting file “user2.dat”. The device control section 21, for a user who has not logged in, creates a temporary user setting file titled “user0.dat” in the first setting information storage section 43 on the basis of the user management table illustrated in FIG. 8.

Next, the device control section 21 (i) controls the web browser section 22 and the communication section 16 for transmission to the server device 50 of a request to transmit screen data on a display screen corresponding to setting information included in the user setting file read in S23 for the logged-in user (or to the temporary user setting file created in S24 for the logged-in user), (ii) obtains the screen data from the server device 50, and (iii) causes the display section 32 to display the display screen (S25). The device control section 21 then, in accordance with the result of analysis by the web browser section 22 of a setting information storage request included in the response data from the server device 50, updates the temporary user setting file stored in the first setting information storage section 43 for the logged-in user (S26).

Specifically, the device control section 21 controls the web browser section 22 and the communication section 16 for transmission to the server device 50 of a screen data transmission request including setting information read from the user setting file for the logged-in user. The web server section 53 of the server device 50, upon receipt of the screen data transmission request from the multifunction peripheral 10, obtains from the web application section 54 response data including (i) screen data corresponding to the setting information included in the transmission request and (ii) a setting information storage request for causing the multifunction peripheral 10 to store new setting information (that is, a request to create a cookie), and transmits the response data to the multifunction peripheral 10 via the communication section 52.

FIG. 9 is an explanatory diagram illustrating example setting information included in a screen data transmission request transmitted from the multifunction peripheral 10 to the server device 50. The example of FIG. 9 illustrates a case of setting information being included as a cookie header in part of an HTTP header of an HTTP request including a screen data transmission request transmitted from the multifunction peripheral 10 to the server device 50. The example of FIG. 9 shows (i) “username” to indicate a key for identifying information that the web application section 54 has caused the multifunction peripheral 10 to store and (ii) “user1” to indicate a value assigned to the above key.

FIG. 10 is an explanatory diagram illustrating an example setting information storage request included in response data transmitted from the server device 50 to the multifunction peripheral 10. The example of FIG. 10 illustrates a case of a setting information storage request included as a Set-cookie header in part of an HTTP header of an HTTP response including screen data transmitted from the server device 50 to the multifunction peripheral 10. The example of FIG. 10 shows (i) “username” to indicate a key for identifying information that the web application section 54 causes the multifunction peripheral 10 to store, (ii) “user1” to indicate a value to be assigned to the above key, (iii) an “expires” identifier to indicate an expiration date and time, (iv) a “path” identifier to indicate a value for a file path, and (v) a “domain” identifier to indicate a value for a domain name.

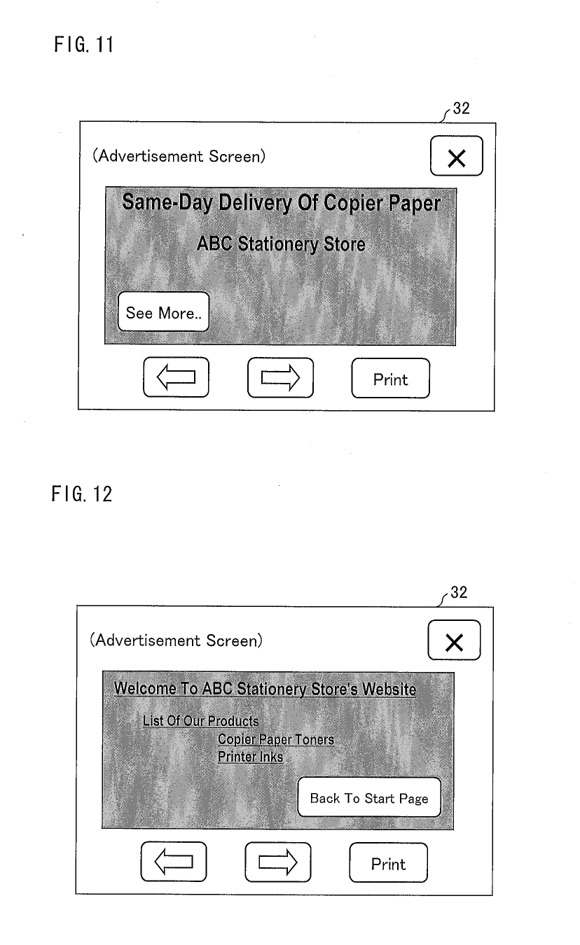

FIG. 11 is an explanatory diagram illustrating an example display screen (web page) displayed by the display section 32 of the multifunction peripheral 10 on the basis of screen data obtained from the server device 50. The example of FIG. 11 illustrates a case of an advertisement screen being displayed which is provided by the web application section 54 of the server device 50. The display screen shows, in addition to advertisement information, a plurality of buttons for the user to press (namely, an “x” button, a “See more . . . ” button, a “<-” button, a “->” button, and a “Print” button).

After S26, the device control section 21 accepts another operation input by the user on the display screen displayed in S25 (S27), and determines whether the operation input by the user is an instruction to close the web browser (S28). In a case where, for instance, the “x” button has been pressed on the display screen of FIG. 11, the device control section 21 determines that the operation input is an instruction to close the web browser. In a case where any other button has been pressed, the device control section 21 determines that the operation input is not an instruction to close the web browser.

In a case where the device control section 21 has determined in S28 that the operation input by the user is not an instruction to close the web browser, the device control section 21 carries out a process corresponding to the operation input accepted in S27 (for example, transmits one of various processing requests to the server device 50) (S29). The device control section 21, in response to a setting information storage request included in the response data from the server device 50 and corresponding to the content of the operation input accepted in S27, updates the temporary user setting file stored in the first setting information storage section 43 for the logged-in user (S30). The device control section 21 then returns to the step S27.

In a case where, for instance, the “See more . . . ” button, the “<-” button, or the “->” button has been pressed on the display screen of FIG. 11, the device control section 21 (i) controls the web browser section 22 and the communication section 16 for transmission to the server device 50 of a request to transmit screen data on a display screen corresponding to the button pressed, (ii) obtains the screen data from the server device 50, and (iii) causes the display section 32 to display the display screen. The device control section 21 then, in accordance with the result of analysis by the web browser section 22 of a setting information storage request included in the response data from the server device 50, updates the temporary user setting file stored in the first setting information storage section 43 for the logged-in user.

The screen data representing the display screen of FIG. 11 is arranged such that image data for the “See more . . . ” button is associated with information on a link destination for a request of transmission of data on a display screen corresponding to the “See more . . . ” button. This arrangement allows (i) the web browser section 22 to analyze such information on a link destination in response to the “See more . . . ” button being pressed and (ii) the device control section 21 to cause a transmission request to be transmitted to a transmission destination corresponding to the result of the analysis. FIG. 12 is an explanatory diagram illustrating an example display screen displayed in response to the “See more . . . ” button being pressed on the display screen of FIG. 11.

The “<-” button (“Back” button) and the “->” button (“Forward” button) shown in FIG. 11 are each a button for screen transition based on a function of the web browser section 22. Pressing the “<-” button causes the web browser section 22 to carry out a process of going back to a web page that was displayed immediately before the current web page became displayed. Pressing the “->” button causes the web browser section 22 to carry out a process of going back to, among all web pages displayed during the current session, a web page that was displayed following the last display of the current web page.

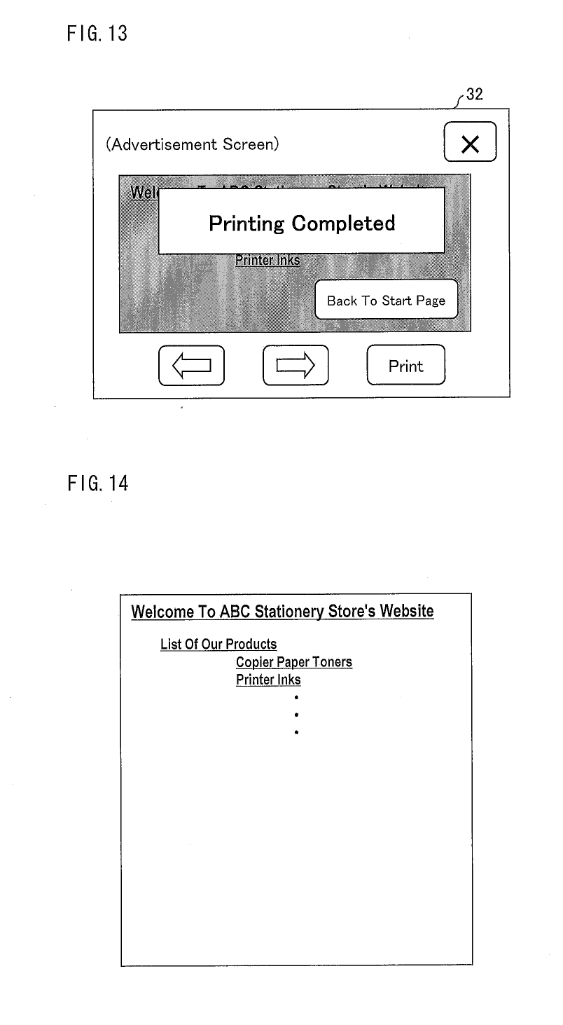

The “Print” button in FIG. 11 is a button for carrying out a printing process based on a function of the web browser section 22. Pressing this button causes the device control section 21 to control the web browser section 22 and the communication section 16 for transmission to the server device 50 of a request to transmit data for printing. Then, upon receipt of data for printing transmitted back from the server device 50, the device control section 21 (i) controls the image forming section 14 so that the image forming section 14 prints, onto a recording sheet, an image represented by the data for printing, and also (ii) causes the display section 32 to display a display screen indicative of completion of printing. FIG. 13 is an explanatory diagram illustrating an example display screen displayed by the display section 32 on completion of printing. FIG. 14 is an explanatory diagram illustrating an example image printed on a recording sheet.

In a case where the device control section 21 has determined in S28 that the operation input by the user is an instruction to close the web browser, the device control section 21 (i) updates, on the basis of the temporary user setting file stored in the first setting information storage section 43 for the logged-in user, the user setting file stored in the second setting information storage section 42 for the logged-in user (S31), (ii) erases the temporary user setting file stored in the first setting information storage section 43 (S32), and proceeds to carry out the step S5 in FIG. 2 (S33), that is, returns to the state in which the operation screen of FIG. 4 is being displayed by the multifunction peripheral 10.

The present embodiment is arranged to, in the case where the operation input accepted in S27 is an instruction to close the web browser, (i) close the web browser, (ii) update the user setting file stored in the second setting information storage section 42 for the logged-in user, and (iii) erase the temporary user setting file stored in the first setting information storage section 43. The present invention is, however, not limited to such an arrangement.

The present invention may be arranged, for instance, to (i) determine whether a predetermined time period has, with the web browser section 22 running, elapsed after last accepting an operation input by the user (or after carrying out a process corresponding to that operation input) and (ii) in a case where no operation input has been performed by the user by a time point at which the predetermined time period has elapsed, cause the device control section 21 to control the log-in process section 23 for a log-out process. In the case of carrying out a log-out process, the device control section 21, on the basis of the corresponding temporary user setting file stored in the first setting information storage section 43, (i) updates the user setting file stored in the second setting information storage section 42 for the logged-in user, and (ii) erases the temporary user setting file stored in the first setting information storage section 43. The present invention may alternatively be arranged to (i) not update the user setting file stored in the second setting information storage section 42 for the logged-in user and simply (ii) erase the temporary user setting file stored in the first setting information storage section 43.

In a case where the device control section 21 has determined in S22 that no user has logged in (that is, no user is in a logged-in state), the device control section 21 (i) controls the web browser section 22 and the communication section 16 for transmission to the server device 50 of a request to transmit screen data on a display screen for a user who has not logged in, (ii) obtains the screen data from the server device 50, and (iii) causes the display section 32 to display the display screen (S34). The device control section 21 then, in accordance with the result of analysis by the web browser section 22 of a setting information storage request included in the response data from the server device 50, creates a temporary user setting file (first setting information) for a user who has logged in, and causes the first setting information storage section 43 to store the temporary user setting file (S35). The present embodiment is arranged to create, for a use who has not logged in, a temporary user setting file with the file name “user0.dat” in the first setting information storage section 43. The user name “user0” indicates a user who has not logged in.

After S35, the device control section 21 accepts another operation input by the user on the display screen displayed by the display section 32 (S36), and determines whether the operation input by the user is an instruction to close the web browser (S37). The steps S36 and S37 may simply be carried out similarly to, for example, the steps S27 and S28.

In a case where the device control section 21 has determined in S37 that the operation input by the user is not an instruction to close the web browser, the device control section 21 determines whether the operation input accepted in S36 is for a process that requires the user to log in (that is, a process that only a user who has logged in to the multifunction peripheral 10 is permitted to perform) (S38).

The present embodiment may be arranged, for instance, to (i) set some processes in advance as processes requiring log-in, (ii) cause the storage section 15 to store information thereon, and (iii) in a case where the operation input accepted in S36 is for one of those processes, determine that the operation input is for a process that requires the user to log in. The present embodiment is arranged to (i) in a case where the operation input accepted in S36 is for one of predetermined apparatus functions involving the use of the image reading section 13 or image forming section 14 (for example, one or more of the following apparatus functions: a printer function, a copying function, a scanner function, a facsimile function, an image data transmitting function, and an image data filing function), determine that the operation input is for a process requiring log-in and (ii) in a case where the operation input accepted in S36 involves only a web browser function, determine that the operation input is for a process not requiring log-in. Thus, in a case where, for instance, the display screen of FIG. 11 or 12 is being displayed, the device control section 21 (i) in a case where the “Print” button has been pressed, determines that the operation input is for a process that requires log-in and (ii) in a case where any one of the “See more . . . ” button, the “Back to Start Page” button, the “<-” button, and the “->” button has been pressed, determines that the operation input is for a process that does not require log-in.

In a case where the device control section 21 has determined in S38 that the operation input accepted in S36 is for a process that requires log-in, the device control section 21 causes the log-in process section 23 to carry out a log-in process (S39), and reads from the second setting information storage section 42 the user setting file (second setting information) for the logged-in user (S40). The device control section 21 then (i) combines the user setting file (second setting information) read from the second setting information storage section 42 with a corresponding temporary user setting file (first setting information) stored in the first setting information storage section 43 for a user who has not logged in (S41), (ii) causes the first setting information storage section 43 to store, in the form of a temporary user setting file (second setting information) for the logged-in user, the temporary user setting file combined with the user setting file, and (iii) proceeds to carry out the step S29.

Specifically, the present embodiment creates, for a user who has not logged in, a temporary user setting file (first setting information) with the file name “user0.dat” in the first setting information storage section 43. Then, in a case where, for instance, the user who has logged in S39 corresponds to a user setting file with the file name “user1.dat”, the present embodiment adds the setting information of “user0.dat” to “user1.dat”. More specifically, the present embodiment (i) in a case where, for instance, an item in “user0.dat” is not included in “user1.dat”, adds that item to “user1.dat” and (ii) in a case where an item in “user0.dat” is included in “user1.dat”, adds setting information for the corresponding item in “user0.dat” to setting information for the corresponding item in “user1.dat” or updates the setting information for that item in “user1.dat” to the setting information for that item in “user0.dat”.

In a case where the device control section 21 has determined in S38 that the operation input accepted in S36 is not for a process that requires log-in, the device control section 21 carries out a process corresponding to the operation input accepted in S36 (for example, transmits one of various processing requests to the server device 50) (S42). The device control section 21, in response to a setting information storage request included in the response data from the server device 50 and corresponding to the content of the operation input accepted in S36, updates the temporary user setting file stored in the first setting information storage section 43 for a user who has not logged in (S43). The device control section 21 then returns to the step S36.

In a case where the device control section 21 has determined in S37 that the operation input by the user is an instruction to close the web browser, the device control section 21 erases the temporary user setting file stored in the first setting information storage section 43 (S44), and proceeds to carry out the step S2 in FIG. 2 (S45), that is, returns to the state in which the authentication screen of FIG. 3 is being displayed.

As described above, the multifunction peripheral 10 of the present embodiment is arranged such that (i) in a case where a user has operated the multifunction peripheral 10 while the user is not in a logged-in state, the device control section 21 causes the first setting information storage section 43 to store, in the form of a temporary user setting file (first setting information) for a user who has not logged in, setting information corresponding to the content of the above operation and that (ii) after a log-in process, the device control section 21 creates a temporary user setting file (second setting information) associating the above temporary user setting file, which corresponds to the content of the operation performed during a predetermined length of time immediately before the log-in process (or performed before the log-in process), with the logged-in user.

Specifically, in a case where the second setting information storage section 42 has stored therein a user setting file (second setting information) for the logged-in user, the device control section 21 creates a temporary user setting file (second setting information) for the logged-in user which temporary user setting file combines (i) the user setting file, stored in the second setting information storage section 42, with (ii) the above temporary user setting file (first setting information), stored in the first setting information storage section 43 for a user who has not logged in. Further, in a case where the second setting information storage section 42 does not have stored therein a user setting file (second setting information) for the logged-in user, the device control section creates a temporary user setting file (second setting information) associating, with the logged-in user, a temporary user setting file (first setting information) stored in the first setting information storage section 43 for a user who has not logged in.

The above arrangement allows the user to, even after log-in, directly use the content of an operation that the user performed immediately before the log-in. The above arrangement consequently eliminates the need for the user to, after log-in, perform again the same operation as the user performed before the log-in, and improves the user's convenience as a result.

Further, the present embodiment is arranged such that after the device control section 21 has caused the first setting information storage section 43 to store a temporary user setting file (first setting information) for a user who has not logged in, the device control section 21 erases that temporary user setting file (first setting information), stored in the first setting information storage section 43 for a user who has not logged in, in a case where (i) no operation has been performed by the user for a predetermined length of time, (ii) a log-out process has been carried out, (iii) the web browser function has been ended, or (iv) use of a web application via a web browser has ended.

The above arrangement can, even in a case where a user who has performed an operation while the user is not in a logged-in state did not perform a process of erasing a temporary user setting file (first setting information) stored in the first setting information storage section 43 for that user who has not logged in, that is, left the temporary user setting file stored, prevent (i) another user from using the temporary user setting file (or learning the content of the operation corresponding to that temporary user setting file) and (ii) the temporary user setting file from being associated by mistake with a user setting file (second setting information) for another user who performs an operation later.

Further, the present embodiment is arranged to, while a user is in a logged-in state, (i) not carry out a process of causing the second setting information storage section 42 of the storage section 15 to store a user setting file (second setting information) for the logged-in user and instead (ii) cause the first setting information storage section 43 of the working memory section 18 to store such a user setting file in the form of a temporary user setting file (first setting information) for the logged-in user, and is further arranged to, when the user logs out, cause the second setting information storage section 42 of the storage section 15 to store, as a user setting file, the temporary user setting file stored in the first setting information storage section 43. This arrangement eliminates the need to access the second setting information storage section 42 of the storage section 15 each time there is a need to update setting information for the logged-in user while the user is in a logged-in state, and allows the device control section 21 to simply access the first setting information storage section 43 of the working memory section 18 to update the setting information. The above arrangement can consequently shorten the processing time required by the multifunction peripheral 10.

The present embodiment described is arranged to create setting information corresponding to the content of a user's operation in a case of the multifunction peripheral 10 carrying out a process involving the web browser function. The present invention is, however, not limited to such an arrangement. The multifunction peripheral 10 may alternatively be arranged to, for instance, cause the device control section 21 to create setting information corresponding to the content of a user's operation and stores that setting information also in a case of using an apparatus function of the multifunction peripheral 10 other than the web browser function.

The present embodiment described is arranged to allow a user who has logged in to the multifunction peripheral 10 to use all apparatus functions of the multifunction peripheral 10. The present invention is, however, not limited to such an arrangement. The multifunction peripheral 10 may, for instance, alternatively be arranged to (i) set one or more apparatus functions of the multifunction peripheral 10 for each user as those usable by the user and (ii) cause an operation screen to be displayed that does not include, for example, operation buttons for apparatus functions that the user are not allowed to use after log-in. The multifunction peripheral 10 may, for instance, further alternatively be arranged to (i) set, for each apparatus function usable by a user, such conditions as the number of times the user is allowed to use the apparatus function, the number of sheets that the user is allowed to use (for example, the number of sheets that the user is allowed to print), and an expiration time and (ii) stop allowing the user to use the apparatus function in a case where any of the conditions is no longer satisfied.

The present embodiment described is arranged such that the web application section 54 of the server device 50 provides the multifunction peripheral 10 with data on a web page including advertisement information. The present invention is, however, not limited to such an arrangement. For instance, the web application section 54 may be an application for providing the multifunction peripheral 10 with a web page indicative of such information as information on current events, weather, and road traffic. Further, the web application section 54 may be an application that operates in cooperation with the multifunction peripheral 10 or an application or the like for carrying out a predetermined process on data received from the multifunction peripheral 10 and transmitting the processed data back to the multifunction peripheral 10. In addition, the multifunction peripheral control system 1 may include a plurality of web applications on the communication network 30 so that a user of the multifunction peripheral 10 can select a desired web application for use.

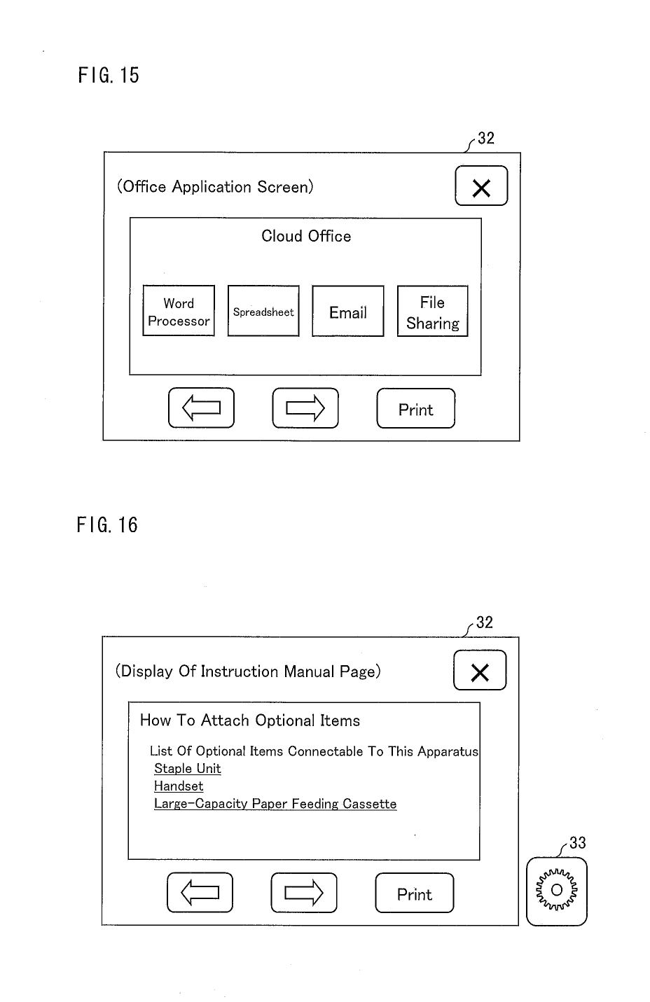

The web application section 54 may be an application for providing a function of an office application (for example, a word processor application, a spreadsheet application, an email application, or a file sharing service). FIG. 15 is an explanatory diagram illustrating an example display screen (web page) displayed on the display section 32 of the multifunction peripheral 10 on the basis of screen data obtained from the server device 50. FIG. 15 illustrates an example display screen displayed on the display section 32 of the multifunction peripheral 10 in a case where the web application section 54 of the server device 50 is an application for providing functions of office applications. The example of FIG. 15 shows, on the display screen, the buttons “Word processor”, “Spreadsheet”, “Email”, and “File sharing”, and is arranged such that a user can press a button for a desired office application to use that office application.

In the case where the web application section 54 is an application for providing a function of an office application as described above, the device control section 21 may (i) determine in S10 of FIG. 2 whether the user has performed an operation to activate the office application, that is, an operation of entering a URL indicative of the server device (web server) 50 that provides an office application through the web browser section (web browser) 22 and (ii) in a case where the device control section 21 has determined that the user has performed an operation to activate the office application, proceed to carry out the step S11 and in a case where the device control section 21 has not determined that the user has performed an operation to activate the office application, return to the step S2.

The present embodiment may be arranged to, in a case where a user (administrator) who has an administrator authority has logged in to the multifunction peripheral 10 during an operation involving use of the web browser section 22, switch to an apparatus setting mode for carrying out apparatus setting that only an administrator is permitted to perform (for example, setting an adjustment value for the apparatus, and resetting the number of sheets to be printed).

Specifically, the present embodiment may be arranged, for instance, such that in a case where a person wants to view a web page of the instruction manual for the multifunction peripheral 10 on the display section 32 of the multifunction peripheral 10, the person can view that web page without log in. This arrangement makes it possible to view a web page of the instruction manual for the multifunction peripheral 10 on the display section 32 of the multifunction peripheral 10 for service work (for example, maintenance work) of the multifunction peripheral 10 without logging in to the multifunction peripheral 10. The above arrangement consequently makes it possible to start service work for the multifunction peripheral 10 quickly. FIG. 16 illustrates an example web page of an instruction manual displayed on the display section 32 of the multifunction peripheral 10. The multifunction peripheral 10 may include, as illustrated in FIG. 16, a log-in button 33 for an administrator to perform a log-in process.

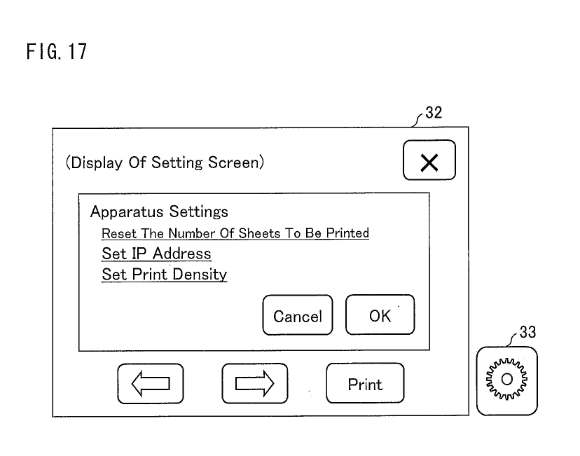

Including the log-in button 33 makes it possible to, in a case where there is a need to switch the multifunction peripheral 10 to the apparatus setting mode during service work, perform a process of logging in to the multifunction peripheral 10 to switch the multifunction peripheral 10 to the apparatus setting mode for apparatus setting. For instance, in a case where the log-in button 33 for an administrator has been pressed while the web browser section 22 is running, the device control section 21 (i) determines in S38 of FIG. 5 that the operation input is for a process that requires log-in, (ii) carries out the steps S39 and later, and further carries out processes such as displaying a screen for apparatus setting, accepting a setting operation, and changing apparatus settings. FIG. 17 is an example display screen for apparatus setting which display screen is displayed on the display section 32 of the multifunction peripheral 10. The example of FIG. 17 illustrates a display screen for apparatus setting as overlaid on a web browser window.

Then, in a case where the logged-in person wants to return to the web browser during the apparatus setting to cause the instruction manual for the multifunction peripheral 10 to be displayed again, the logged-in person can, since the multifunction peripheral 10 has stored therein a cookie on the web page that the person viewed before the log-in, quickly return, with use of the cookie, to the web page that the person viewed before the log-in (for example, the web page of the instruction manual for the multifunction peripheral 10). This arrangement eliminates the need for an administrator to perform the operation again to access the web page corresponding to the instruction manual for the multifunction peripheral 10, and consequently improves the administrator's working efficiency.

In the case where the web application section 54 is an application for providing a web page of the instruction manual for the multifunction peripheral 10 as described above, the device control section 21 may (i) determine in S10 of FIG. 2 whether the user has performed an operation to open the web page of the instruction manual for the multifunction peripheral 10, that is, an operation of entering a URL indicative of the server device (web server) 50 that provides the web page of the instruction manual through the web browser section (web browser) 22 and (ii) in a case where the device control section 21 has determined that the user has performed an operation to open the web page of the instruction manual, proceed to carry out the step S11 and in a case where the device control section 21 has not determined that the user has performed an operation to open the web page of the instruction manual, return to the step S2.

In the present embodiment, each control section included in the multifunction peripheral 10 and the server device 50, particularly the control section 11 and the control section 51, may be realized by software by using a processor such as a CPU. In this case, the multifunction peripheral 10 and the server device 50 may include a CPU (central processing unit) for executing a program for realizing functions of each section, a ROM (read only memory) that stores the program, a RAM (random access memory) that develops the program, a storage device (storage medium) such as a memory in which the program and various data are stored, and the like. In this case, the object of the present invention can be realized in such a manner that the multifunction peripheral 10 and the server device 50 is provided with a computer-readable storage medium for storing program codes (such as executable program, intermediate code program, and source program) of control programs of the multifunction peripheral 10 and the server device 50 which programs serve as software for realizing the functions, and a computer (alternatively, a CPU or an MPU) reads out and executes the program codes stored in the storage medium.

Examples of the storage medium include (i) a tape such as a magnetic tape and a cassette tape, (ii) a disk including a magnetic disk such as a floppy (registered trademark) disk and a hard disk, and an optical disk such as a CD-ROM, an MO, an MD, a DVD, and a CD-R, (iii) a card such as an IC card (including a memory card) and an optical card, and (iv) a semiconductor memory realized by a mask ROM, an EPROM, an EEPROM (registered trademark), a flash ROM, and the like.

The multifunction peripheral 10 and the server device 50 can be connected to a communication network, via which the program codes can be supplied to the multifunction peripheral 10 and the server device 50. Such a communication network is not particularly limited. Examples of the communication network includes the Internet, an intranet, an extranet, a LAN, ISDN, VAN, a CATV communications network, a virtual private network, a telephone network, a mobile telecommunications network, and a satellite communication network. A transmission medium of which a communication network is composed is not particularly limited. Examples of the transmission medium includes (i) a wired transmission medium such as IEEE 1394, a USB, a power-line carrier, a cable TV line, a telephone line, and an ADSL line and (ii) a wireless transmission medium such as an infrared communication system such as IrDA and a remote controller, Bluetooth (registered trademark), 802.11 wireless communication system, HDR, a mobile phone network, a satellite line, and a digital terrestrial network. Note that the present invention can also be realized in the form of a computer data signal in which the program codes are embodied by an electronic transmission and which is embedded in carrier waves.

Further, each block of the multifunction peripheral 10 and the server device 50 is not necessarily realized by software, but may be realized by, for example, hardware logic, and may be realized by a combination of hardware carrying out some of the processes and computing means controlling the hardware and executing program code for the other processes.

As described above, a setting information storage device of one mode of the present invention is a setting information storage device (i) including an operation section for accepting an operation input by a user and (ii) storing setting information corresponding to a content of an operation performed by the user on the operation section, the setting information storage device including: a storage section; a log-in process section for carrying out a log-in process of determining on a basis of a result of a user authentication process whether to permit a user to log in; and a setting information control section for (i) causing the storage section to store first setting information, which is setting information corresponding to a content of an operation performed by a user while the user is not in a logged-in state and (ii) after the log-in process, creating second setting information, which associates the first setting information, corresponding to the content of the operation performed by the user before the log-in process, with the logged-in user and causing the storage section to store the second setting information.

The above arrangement makes it possible to create second setting information associating (i) first setting information corresponding to the content of an operation performed before a log-in process with (ii) the logged-in user, and thus allows the user to, after the log-in, directly use the content of an operation performed immediately before the log-in. The above arrangement consequently eliminates the need for the user to, after log-in, perform again the same operation as the user performed before the log-in, and improves the user's convenience as a result.

The setting information storage device may be arranged such that the setting information control section causes the storage section to erase the first setting information, which the setting information control section has caused the storage section to store, in a case where no operation input has been performed on the operation section by a time point at which a predetermined length of time elapses after the setting information control section has caused the storage section to store the first setting information.

The above arrangement can, in a case where a user who has performed an operation input while the user is not in a logged-in state did not erase first setting information corresponding to the content of the above operation, that is, left the first setting information stored, prevent (i) another user from using the first setting information (or learning the content of the operation corresponding to the first setting information) and (ii) the first setting information from being associated by mistake with second setting information for another user who performs an operation later.

The setting information storage device may be arranged such that the setting information control section has a web browser function of communicating with a web server over a communication network; the setting information control section causes the storage section to store, as the first setting information in response to an instruction from an application operating on the web server, setting information corresponding to a content of an operation performed on the application by the user while the user is not in the logged-in state; and the setting information control section, after the log-in process, creates second setting information associating the first setting information, corresponding to a content of an operation performed on the application before the log-in process, with the logged-in user.

The above arrangement makes it possible to create second setting information that associates, with the logged-in user, first setting information corresponding to the content of an operation performed before log-in on an application operating on a web server, and allows the user to, after log-in, directly use the content of an operation performed immediately before the log-in. The above arrangement consequently eliminates the need for the user to, after log-in, perform again the same operation as the user performed before the log-in, and improves the user's convenience.

The setting information storage device may be arranged such that the setting information control section causes the storage section to erase the first setting information, which the setting information control section has caused the storage section to store, in a case where the setting information control section has ended the web browser function or use of the application after the setting information control section has caused the storage section to store the first setting information.

The above arrangement can, in a case where a user who has performed an operation on the application while the user is not in a logged-in state did not perform a process of erasing first setting information stored in the storage section and corresponding to the content of the above operation, that is, left the first setting information stored, prevent (i) another user from using the first setting information (or learning the content of the operation corresponding to the first setting information) and (ii) the first setting information from being associated by mistake with second setting information for another user who performs an operation later.

The setting information storage device may be arranged such that the setting information control section obtains, from the application, information representing a screen and causes the screen to be displayed in a case where no operation input has been performed by the user for a predetermined time period or longer.

The above arrangement makes it possible to, in a case where no operation input has been performed by the user for a predetermined time period or longer, obtain information representing a screen from an application operating on a predetermined web server and cause the screen to be displayed.

The setting information storage device may be arranged such that the storage section includes a first storage section for storing the first setting information and a second storage section for storing the second setting information; the first storage section requires a shorter time in reading and writing data than the second storage section; the log-in process section has a function of carrying out a log-out process of canceling the logged-in state to log out the user; the setting information control section (i) causes the first storage section to store the second setting information while the user is in the logged-in state and (ii) updates the second setting information, stored in the first storage section, with use of setting information corresponding to a content of an operation performed by the logged-in user; and the setting information control section, in a case where the log-in process section carries out the log-out process, causes the second storage section to store the second setting information stored in the first storage section.

The above arrangement makes it possible to, while the user is in a logged-in state, manage second setting information with use of the first storage section, which requires a shorter time in reading and writing data than the second storage section. The above arrangement can consequently shorten the processing time as compared to a case of managing second setting information with use of the second storage section even while the user is in a logged-in state.

The setting information storage device may be arranged such that in the case where the log-in process section carries out the log-out process, the setting information control section, after causing the second storage section to store the second setting information stored in the first storage section, erases the second setting information stored in the first storage section.

The above arrangement can prevent setting information for a user who has performed a log-out process from being learned by another user who performs an operation input later.

An image processing apparatus of the present invention is an image processing apparatus having at least one of a printer function, a copying function, a scanner function, and a facsimile function, the image processing apparatus having a function of any of the above setting information storage devices.

The above arrangement can improve the user's convenience in use of an image processing apparatus having a function of storing setting information corresponding to the content of an operation performed by the user.

The present invention is not limited to the description of the embodiment above, but may be altered in various ways by a skilled person within the scope of the claims. Any embodiment based on a combination of technical means properly altered within the scope of the claims is also encompassed in the technical scope of the present invention.

### INDUSTRIAL APPLICABILITY

The present invention is applicable as (i) a setting information storage device for storing setting information corresponding to the content of a user's operation and as (ii) an image processing apparatus including the setting information storage device.

### REFERENCE SIGNS LIST

1 multifunction peripheral control system (setting information storage system)
10 multifunction peripheral (setting information storage device)
11 control section (setting information control section)
12 operation section
13 image reading section
14 image forming section
15 storage section
16 communication section
17 time measurement section
18 working memory section
21 device control section (setting information control section)
22 web browser section (setting information control section)
23 log-in process section
30 communication network
31 input section
32 display section
40 screen data storage section
41 authentication information storage section
42 second setting information storage section (storage section, second storage section)
43 first setting information storage section (storage section, first storage section)
44 log-in status storage section
50 server device
51 control section
52 communication section
53 web server section
54 web application section

1. A setting information storage device (i) including an operation section for accepting an operation input by a user and (ii) storing setting information corresponding to a content of an operation performed by the user on the operation section,
the setting information storage device comprising:
a storage section;
a log-in process section for carrying out a log-in process of determining on a basis of a result of a user authentication process whether to permit a user to log in; and
a setting information control section for (i) causing the storage section to store first setting information, which is setting information corresponding to a content of an operation performed by a user while the user is not in a logged-in state and (ii) after the log-in process, creating second setting information, which associates the first setting information, corresponding to the content of the operation performed by the user before the log-in process, with the logged-in user and causing the storage section to store the second setting information.

2. The setting information storage device according to claim 1,
wherein
the setting information control section causes the storage section to erase the first setting information, which the setting information control section has caused the storage section to store, in a case where no operation input has been performed on the operation section by a time point at which a predetermined length of time elapses after the setting information control section has caused the storage section to store the first setting information.

3. The setting information storage device according to claim 1,
wherein:
the setting information control section has a web browser function of communicating with a web server over a communication network;
the setting information control section causes the storage section to store, as the first setting information in response to an instruction from an application operating on the web server, setting information corresponding to a content of an operation performed on the application by the user while the user is not in the logged-in state; and
the setting information control section, after the log-in process, creates second setting information associating the first setting information, corresponding to a content of an operation performed on the application before the log-in process, with the logged-in user.

4. The setting information storage device according to claim 3,
wherein
the setting information control section causes the storage section to erase the first setting information, which the setting information control section has caused the storage section to store, in a case where the setting information control section has ended the web browser function or use of the application after the setting information control section has caused the storage section to store the first setting information.

5. The setting information storage device according to claim 3,
wherein
the setting information control section obtains, from the application, information representing a screen and causes the screen to be displayed in a case where no operation input has been performed by the user for a predetermined time period or longer.

6. The setting information storage device according to claim 1,
wherein:
the storage section includes a first storage section for storing the first setting information and a second storage section for storing the second setting information;
the first storage section requires a shorter time in reading and writing data than the second storage section;
the log-in process section has a function of carrying out a log-out process of canceling the logged-in state to log out the user;
the setting information control section (i) causes the first storage section to store the second setting information while the user is in the logged-in state and (ii) updates the second setting information, stored in the first storage section, with use of setting information corresponding to a content of an operation performed by the logged-in user; and
the setting information control section, in a case where the log-in process section carries out the log-out process, causes the second storage section to store the second setting information stored in the first storage section.

7. The setting information storage device according to claim 6,
wherein
in the case where the log-in process section carries out the log-out process, the setting information control section, after causing the second storage section to store the second setting information stored in the first storage section, erases the second setting information stored in the first storage section.

8. An image processing apparatus having at least one of a printer function, a copying function, a scanner function, and a facsimile function,
the image processing apparatus comprising
the setting information storage device according to claim 1.
